(19) United States
(12) Patent Application Publication
(10) Pub. No.: US 2008/0219690 A1
(43) Pub. Date: Sep. 11, 2008

(54) Image forming method, image forming system, image forming apparatus, and computer readable storage medium for image forming program

(75) Inventor: Koichi Ono, Kasukabe-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/812,025

(22) Filed: Jun. 14, 2007

(30) Foreign Application Priority Data
Mar. 5, 2007 (JP) 2007-053936

(51) Int. Cl. G03G 15/00

(52) U.S. Cl. 399/82

(57) ABSTRACT

The image forming method for executing the proof printing based on a printing job for printing images on recording sheets including a sheet has a step 1) of selecting an substitutive sheet to be used in place of a tab sheet specified in the printing job, and a step 2) of giving an instruction to print a tab sheet image to be printed on the tab of the tab sheet and an outline image representing at least a portion of the tab sheet, on the substitutive paper selected in the step 1).

### CROSS-REFERENCE TO RELATED APPLICATION

This application is based on Japanese Patent Application No. 2007-53936, filed on Mar. 5, 2007, the contents of which are incorporated herein by reference.

### BACKGROUND

1. Technical Field

The invention relates to an image forming method, an image forming system, an image forming apparatus, and a computer readable storage medium for an image forming program. The invention particularly relates to an image forming apparatus, an image forming method, and a computer readable storage medium for an image forming program used for executing proof printing on a substitutive sheet in place of a tab sheet when tab printing is specified.

2. Description of Related Art

It has been noted in recent years that there are many image forming apparatuses that are equipped with a proof printing function. The proof printing function is a function to output a portion of a document for printing before conducting the normal printing, through which the user can check if there is any printing errors in terms of printing positions and image quality prior to the normal printing.

It has also been noted that there are many image forming apparatuses that are equipped with a tab printing function. The tab printing function is a function of inserting tab sheets at breakpoints of chapters and paragraphs of a document, and printing information concerning the particular chapters and paragraphs on the tabs (hereinafter also called “index dividers”) of the tab sheets. A tab sheet mentioned here consists of a rectangular main body and a protruding tab provided at a specific position of the main body.

It is customary to use real tab sheets even for proof printing when the proof printing function is executed in conjunction with the tab printing function, and this causes a problem that expensive tab sheets can be wasted if proof printing processes are repeated many times because of the fact that the output results of the proof printing are unsatisfactory to the user.

To overcome such a problem, a method has been disclosed to replace the tab sheet with a plain sheet of paper of the equivalent size to that of the original tab sheet. See Unexamined Publication No. 2003-22176.

The “equivalent size” means a size equal to the rectangular main body of the tab sheet. However, even if proof printing is executed using this method, there still remains a problem that the user cannot check the printing position in a rigorous manner as it is difficult to lay a real tab sheet precisely over the print output on a sheet of plain paper.

### SUMMARY

It is an object of the present invention to provide an image forming method, an image forming system, an image forming apparatus, and a computer readable storage medium for an image forming program. The invention particularly relates to an image forming apparatus, an image forming method, and a computer readable storage medium for an image forming program, which enable an user to check the printing position on a tab sheet in the case when the proof printing is executed based on a printing job for printing images on recording sheets including a tab sheet.

To achieve at least one of the abovementioned objects, the image forming method reflecting one aspect of the present invention for executing the proof printing based on a printing job for printing images on recording sheets including a tab sheet includes a step 1) and step 2). The step 1) is selecting a substitutive sheet to be used instead of or in place of a tab sheet specified in the printing job. The step 2) is giving an instruction to print on the substitutive sheet selected in the step 1), a tab image to be printed on the tab of the tab sheet and an outline image that represents at least a portion of the outline of the tab sheet.

In the abovementioned image forming method, in particular in the step 2), it is preferable that the tab image and the outline image are shifted by a length that causes them to fit into the surface of the substitutive sheet.

In the abovementioned image forming method, in particular in said step 2), it is preferable that an instruction is also given to print information that specifies the tab sheet to be used.

The objects, characteristics and properties of this invention other than those set forth above will become apparent from the description given herein below with reference to preferred embodiments illustrated in the accompanying drawings.

### BRIEF DESCRIPTION OF THE DRAWINGS

FIG. 1 is a block diagram showing the entire constitution of a printing system wherein an MFP according to an embodiment of the present invention is applied.

FIG. 2 is a block diagram showing the constitution of a PC shown in FIG. 1.

FIG. 3 is a block diagram showing the constitution of an MFP shown in FIG. 1.

FIG. 4 is a diagram showing an example of menu items for tab printing.

FIG. 5 is an diagram showing an example of UI screen for setting up printing conditions.

FIG. 6 is a diagram showing an example of UI screen for setting up printing conditions.

FIG. 7 is a diagram showing an example of UI screen for setting up conditions on substitutive sheet.

FIG. 8 is a flowchart showing the process sequence of the printer driver.

FIG. 9 is a flowchart showing the process sequence of the MFP.

FIG. 10 is a flowchart showing the process sequence of the MFP.

FIG. 11 is a diagram showing an example of the process sequence for creating a printing image for the substitutive sheet.

FIG. 12 is a diagram showing an example of the process sequence for creating a printing image for the substitutive sheet.

FIG. 13 is a diagram showing an example of the method for user's checking.

FIG. 14 is a diagram showing an example of the method for user's checking.

### DETAILED DESCRIPTION

The embodiment of this invention will be described below with reference to the accompanying drawings.

The preferred embodiments of the invention will be described in detail below with reference to the accompanying drawings.

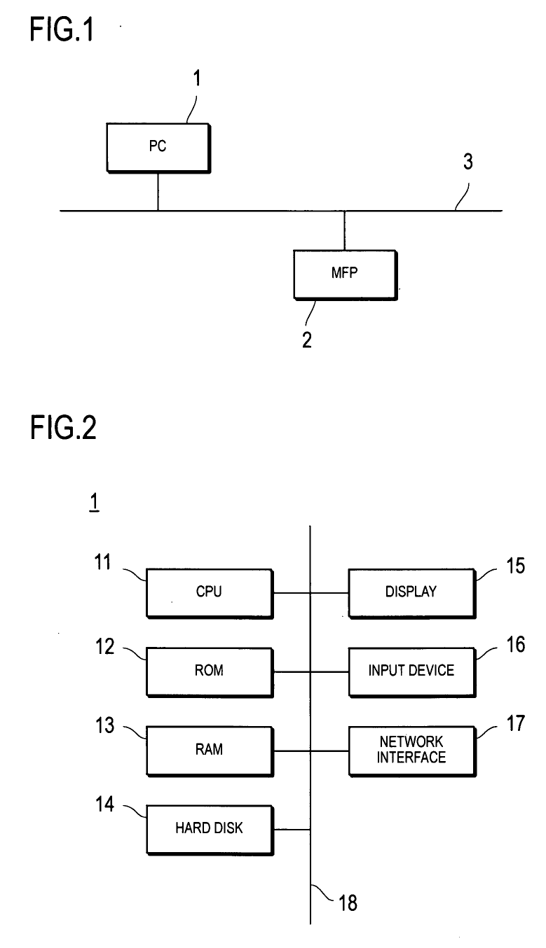

FIG. 1 is a block diagram showing the entire constitution of an image processing system using a printing system according to a first embodiment of the present invention. As shown in FIG. 1, the printing system according to the present embodiment is equipped with a PC 1 as a client apparatus, and an MFP (Multiple Function Peripheral) 2 as an image forming apparatus, which are connected via a communication network 3 to communicate with each other. The types and the number of equipment to be connected to the communication network 3 are not limited to those shown in FIG. 1. Moreover, the PC 1 can be connected with MFP 2 directly (local connection) without going through the communication network 3.

Next, the constitution of each device will be described and it is noted here that each of those devices can include constituents other than those to be described later or can include only a part of the constituents to be described later. Also, the description of a function common to multiple devices will be made only once when it appears first time and will not be repeated afterwards in order to avoid duplicate descriptions.

FIG. 2 is a block diagram showing the constitution of PC 1 shown in FIG. 1. The PC 1 contains a CPU 11, a ROM 12, a RAM 13, a hard disk 14, a display 15, an input device 16 and a network interface 17, all of which are interconnected via a bus 18 for exchanging signals.

The CPU 11 controls various parts indicated above and executes various arithmetic processes according to a program. The ROM 12 stores various programs and data. The RAM 13 stores programs and data temporarily as a working area. The hard disk 14 stores various programs including an operating system and data.

An application program for generating document files and a printer driver for converting document files into printing data (hereinafter called “PDL data” as well) described in a Page Description Language (“PDL”) understood by the MFP 2 are installed on the hard disk 14. Upon receiving the printing instruction for a document file from the application, the printer driver issues a printing instruction for the printing data by describing the printing setup condition that includes a tab printing instruction, a confirmation printing instruction, and the like in the printing data, and transmitting it as a printing job to the MFP 2. The printer drive contains programs for executing such a conversion process and printing instruction.

The display 15 can be LCD, CRT, and other displays, on which various kinds of information are displayed. The input device 16 includes a pointing device such as a mouse, a keyboard, and others, and is used for executing various kinds of information inputs.

The network interface 17 is an interface for communicating with other devices via the network 3 using standards such as Ethernet®, Token Ring, FDDI, etc.

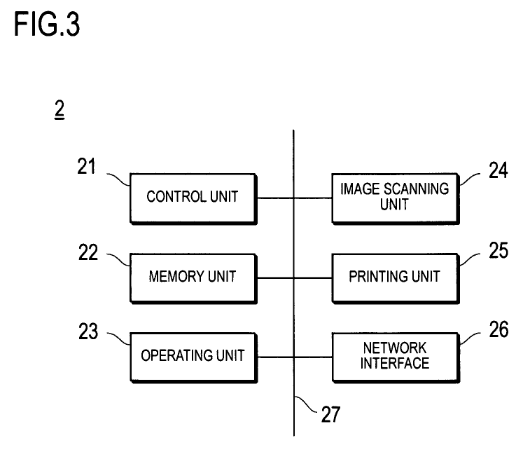

FIG. 3 is a block diagram showing the constitution of the MFP 2 used as an image forming apparatus according to the present embodiment. As shown in FIG. 3, the MFP 2 contains a control unit 21, a storage unit 22, an operating unit 23, an image scanning unit 24, a printing unit 25, and a network interface 26, all of which are interconnected via a bus 27 for exchanging signals.

The control unit 21 is a CPU, and controls various parts indicated above and executes various arithmetic processes according to a program.

The memory unit 22 includes a ROM for storing various programs and parameters, a RAM for temporarily storing programs and data, a hard disk used for temporarily saving image data obtained from image forming, etc.

The operating unit 23 consists of a touch panel for displaying various information and entering various setup inputs, a ten key pad for setting up the number of copies to make and others, a start key for instructing a start of an operation, a stop key for instructing a stop of an operation, various fixed keys such as a reset key for initializing various setup conditions, indicator lamps, etc.

The image scanning unit 24 irradiates light to a document set on the specified scanning position or a document transported to the specified scanning location by an ADF (Auto Document Feeder) with a light source such as a fluorescent lamp and the like, converts reflected lights from the document surface into electrical signals with the help of light sensitive devices such as CCD or CMOS image sensors, and generates bit-map-formatted printing image from the electrical signals.

The printing unit 25 prints printing images on printing media by means of the electrophotographic method consisting of electrical charging, exposure, development, transfer and fixing processes. However, the printing method of the printing unit 25 in this invention is not limited to this, and methods such as the impact method, thermal transfer method, inkjet method, etc. can be used in addition to the electrophotographic method.

The network interface 26 is an interface for communications between the MFP 2 and external equipment, for which various local connection interfaces, e.g., network interfaces such as Ethernet (trademark), Token Ring, and FDDI standards, serial interfaces such as USB and IEEE 1394, parallel interfaces such as SCSI, IEEE 1284, and wireless communication interfaces such as Bluetooth (registered mark), IEEE 802.11, HomeRF, IrDA, as well as telephone circuit interfaces for connection to telephone circuits can be used.

Because of the abovementioned constitutions, the MFP 2 has the function as a printer for printing the image data received from external equipment, the function as a scanner for scanning the document and transmitting the image data to external equipment, the function as a copying machine for scanning the document image and printing it, and the function as a facsimile machine for receiving and transmitting image data through telephone circuits. The MFP 2 also has the function to send and receive email, being able to send and receive email with the network 3 and other communication equipment having the email sending and receiving capability on the network 3 via the network 3, and the function to print out the attached files of the received email.

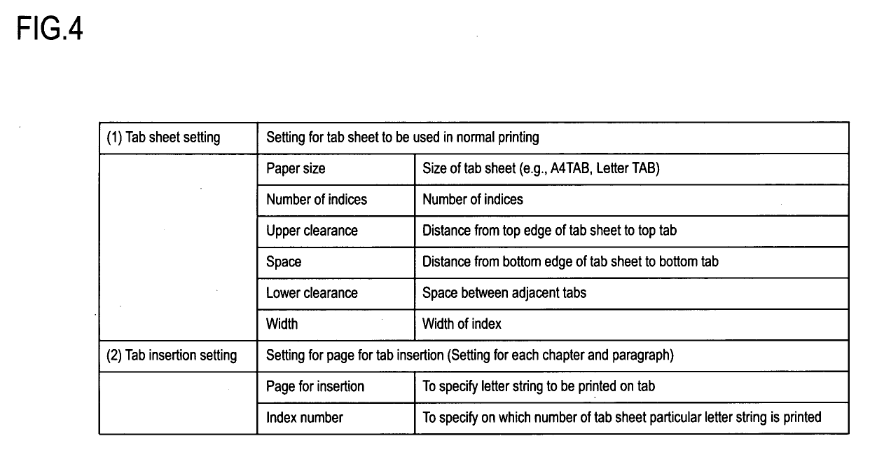

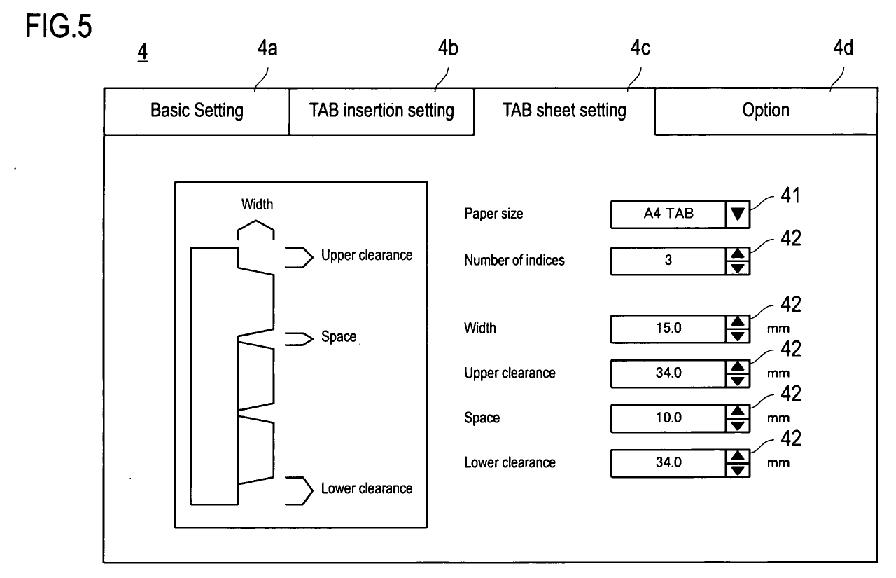

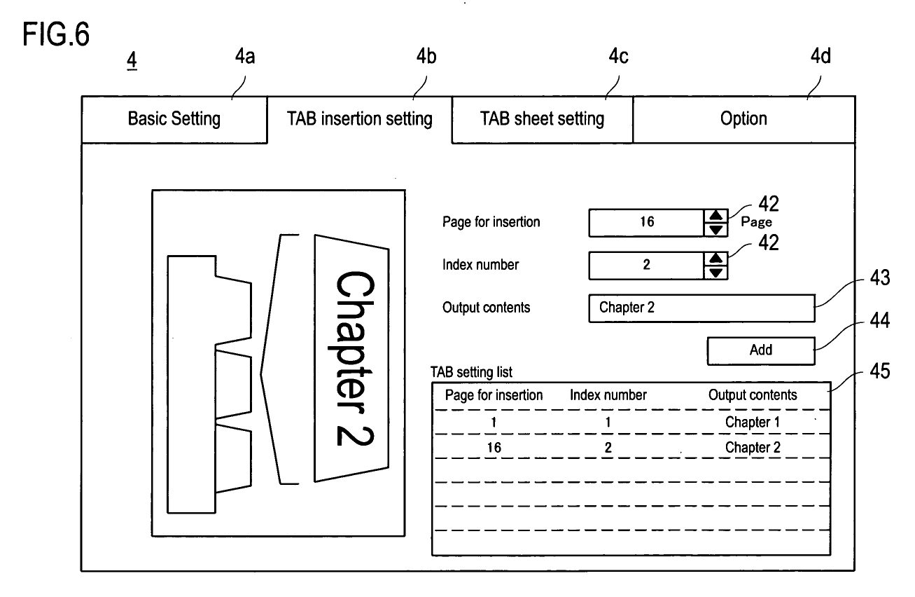

The operation of the tab printing function in the present embodiment will be described in the following. FIG. 4 shows an example of the menu items for the tab printing in the present embodiment, wherein the user specifies desired conditions about each item by operating the UI screen 4 (FIGS. 5 and 6) provided by the printer driver for the printing setup.

In FIG. 4, the menu items for the tab printing can be divided into “TAB sheet setting” concerning the tab sheets to be used and the “TAB insertion setting” concerning the pages where the tab sheets are inserted. The “TAB sheet setting” includes “Paper size” for specifying tab sheets such as A4TAB and Letter TAB, “Number of index” for specifying the total number of tab sheets to be inserted, “Upper clearance” for specifying the distance from the top edge of the tab sheet to the highest tab, “Space” for specifying the space between adjacent tabs, and “Lower clearance” for specifying the distance from the bottom edge of the tab sheet to the bottom index (tab) position. The “TAB insertion setting” includes the “Page for insertion” for specifying the position (page number of the document) where the tab sheet is inserted, the “Output contents” for specifying the letter string to be printed on the tab, and “Index number” for specifying on which number of tab sheet the particular letter string is to be printed.

FIGS. 5 and 6 show examples of the UI screen 4 for setting up the printing conditions provided by the printer driver in the present embodiment. In FIGS. 5 and 6, the UI screen 4 includes four windows 4c through 4d that are switchable by tab operations, while FIG. 5 shows the window 4a for the aforementioned “TAB sheet setting” and FIG. 6 shows the window 4b for the aforementioned “TAB insertion setting”. With reference to FIG. 5, the user selects detailed setting for the tab sheet to be used for the tab printing through a pull-down menu 41 or buttons 42 corresponding to various individual menu items. With reference to FIG. 6, the user selects detailed settings concerning a page to which a tab sheet is inserted through buttons 42, a text field 43, and a button 44. The selected settings in a window 4b are displayed in a list 45. In the present embodiment, the settings selected in the windows 4c and 4b will treated as “tab setting information” to be referenced later during the execution of the proof printing. This will be described again in detail later.

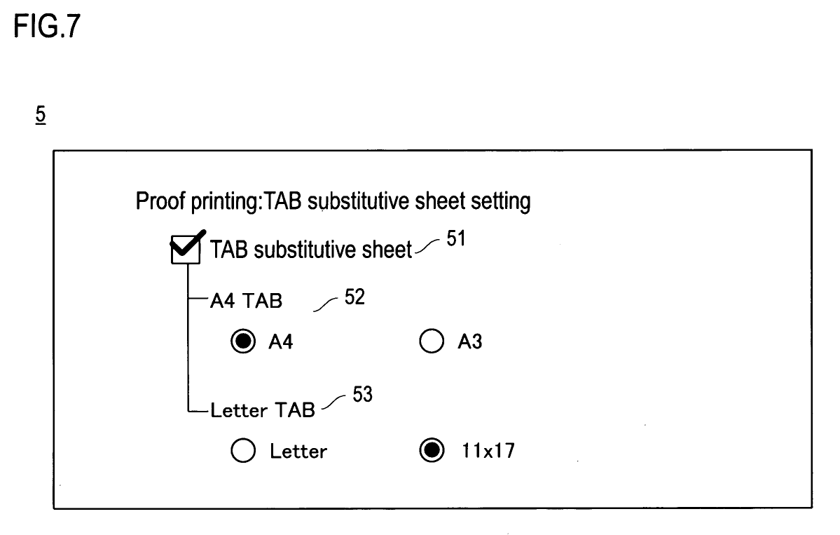

Here is an explanation of the process sequence to be executed when the proof printing and the tab printing are specified at the same time. In the present embodiment, a sheet of plain paper of a specified size can be used for the proof printing as a substitutive sheet in place of a tab sheet, in the case when these two functions are specified simultaneously. The size of such a substitutive sheet can be specified for each of the paper sizes by the user operating the operating unit 23 of the MFP 2 beforehand. FIG. 7 shows an example of the UI screen 5 to be displayed on the operating unit 23 for user's setting up conditions concerning the substitutive sheet in the present embodiment.

On the UI screen 5 shown in FIG. 7, the user can select use of a substitutive sheet by check-marking a checkbox 51 of the “TAB substitutive sheet”, and select the size of the plain paper to be used as a substitutive sheet by mean of a radio button 52. Based on the setting selected on the UI screen 5, the control unit 21 creates substitutive sheet information. Such substitutive sheet information is referenced during the preparation of the image data to be printed on the substitutive sheet. This will be described again in detail later. In the present embodiment, a substitutive sheet of the size either equivalent to or larger than that of the original tab sheet can only be selectable. In the example shown in FIG. 7, either an A4 sheet or an A3 sheet can only be selected as a substitutive to an A4 TAB sheet, while either a Letter size sheet or a sheet of 11 cm×17 cm size are selectable as an substitutive to a Letter TAB sheet.

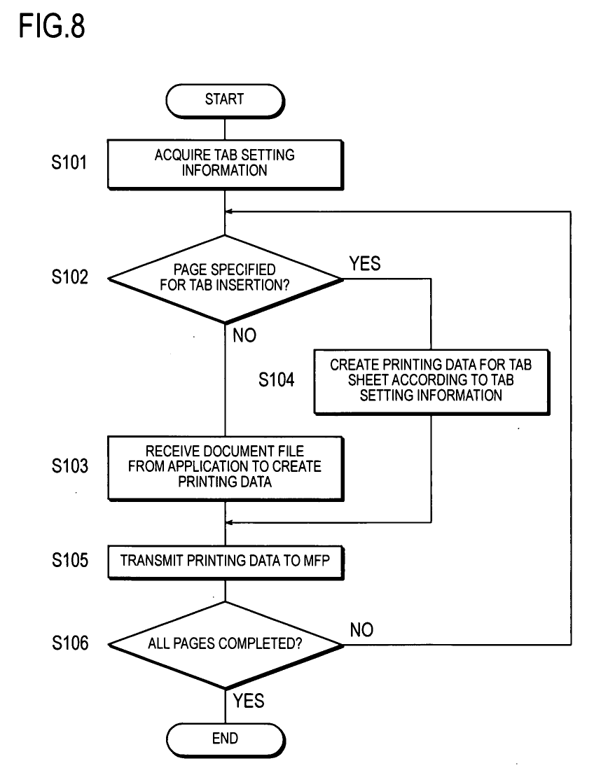

Next, an explanation of the processes executed by the printer driver follows. FIG. 8 is a flowchart showing the process sequence of the printer driver. In the current description, there is an assumption that the “substitutive tab paper function” has been selected by the user operating the UI screen 5 as shown in FIG. 7 prior to the start of the processes by the printer driver, together with the substitutive paper setting of “A4TAB=A4” and “Letter TAB=Letter”,

The printer driver acquires the tab setting information indicating the setup conditions concerning the tab printing specified on the UI screen 4 as shown in FIGS. 5 and 6 (S101).

Next, prior to receipt of the document file for printing from an application software and subsequent creation of printing data on a page-by-page basis, the printer driver make a judgment as to whether or not any tab paper insertion is specified for the page to be processed. If no tab insertion is specified (S102: No), the portion of the document file corresponding to the particular page is received from the application, and the printing data is created accordingly (S103). On the other hand, if tab insertion is specified (S105: Yes), the printing data for the tab sheet is also created based on the aforementioned tab setting information while the printing data for the particular page is created like in S103 (S104).

Next, the printer driver transmits the printing data created either in S103 or S104 to the MFP2 (S105), and then makes a judgment as to whether or not the printing data for all the pages of the document file have been created. If the printing data for all the pages have been created (S106: Yes), the process sequence shall end, and if the printing data for all the pages of the document file have not been created (S106: No), the aforementioned process after S102 shall be repeated.

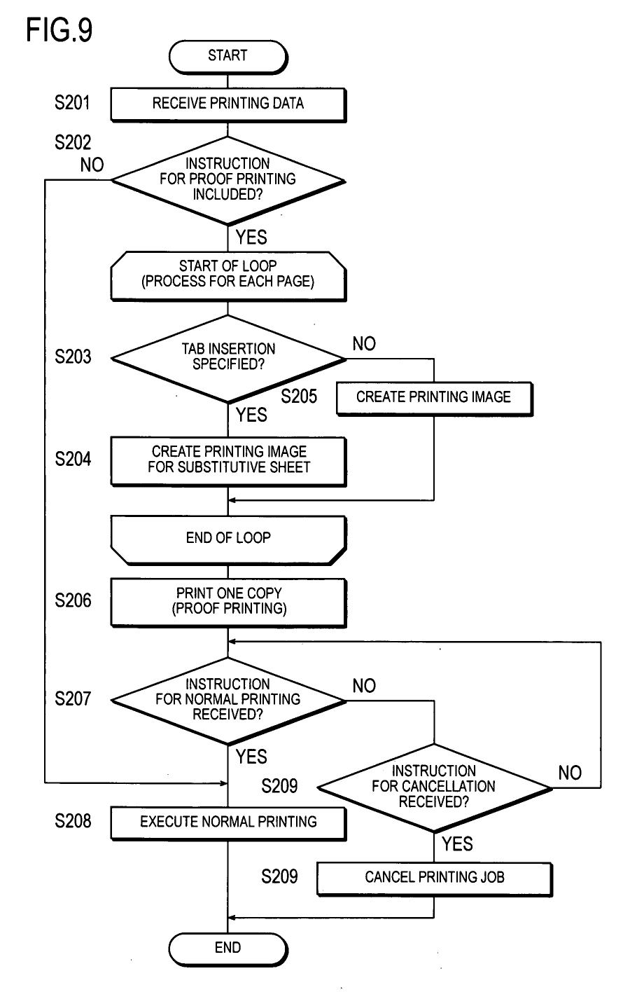

Next, the process sequence of the MFP 2 after receiving the printing data from the printer data will be described below. FIG. 9 is a flowchart showing the process sequence executed by the control unit 21 of the MFP 2.

First, the control unit 21 receives the printing data transmitted from the printer driver (S201). Next, the control unit 21 makes a judgment in S202 as to whether instruction of proof printing is included in the printing data or not. If the proof printing is not specified therein (S202: No), an instruction of normal printing (instead of proof printing) is given to the printing unit 25 (S208), and the process sequence is terminated. If printing of multiple copies is specified in such normal printing, the specified number of copies will be printed. If tab insertion is specified in the normal printing, the specified tab insertion shall be performed.

On the other hand, if the proof printing is specified (S202: Yes), the control unit 21 goes into to the control loop consisting of the steps S203 to S205. In other words, the control unit 21 executes the steps of S203 to S205 page by page (sequentially from the first to the last pages). First, a judgment is made as to whether the page to be processed is a page where the tab insertion is specified or not in S203. If the tab insertion is not specified for the particular page (S203: No), the printing image (raster data) for the page is created (step S205). On the other hand, if the tab insertion is specified for the particular page (S203: Yes), the raster data is created for printing on the substitutive sheet selected on the UI screen 5 of FIG. 7 (S204).

When the loop of the steps S202 to S205 is completed for all the pages, an instruction is given to the printing unit 25 to print only one copy for user's checking of the print output (S206).

After the proof printing is executed in S206, the control unit 21 either acquire an instruction for the normal printing by the operating unit 23, or stand by for the normal printing until an instruction for cancellation is received (S207: No, S209: No). Upon receiving an instruction for the normal printing (S207: Yes), the control unit 21 executes the normal printing (S208) and terminates the sequence. Also, when an instruction for cancellation of the normal printing is received (S209: Yes), the printing job is cancelled (S210) and the process is terminated.

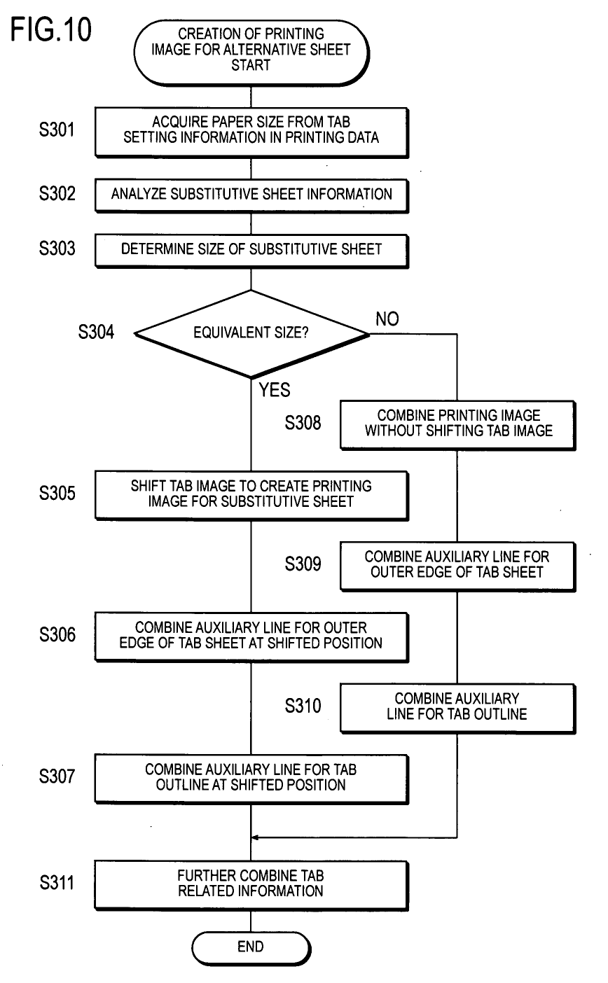

Next, the process sequence for creating the printing image for the substitutive sheet in S204 will be described below. FIG. 10 is a flowchart showing the process sequence executed by the control unit 21.

First, the control unit 21 acquires the information concerning the size of the tab sheet for the page to be processed, from the tab setting information in the printing data (S301). Next, the substitutive sheet information acquired by the operating unit 23 is analyzed (S302), and the size of the substitutive sheet to be used in place of the tab sheet for the proof printing is determined based on the result of the analysis of the substitutive sheet information in S302 and the tab setting information acquired in S301 (S303).

Next, the control unit 21 makes a judgment as to whether or not the size of the substitutive sheet determined in S303 is equivalent to that of the original tab sheet. At this point, the printing image for the substitutive sheet is created either in the steps S305 to S307 in the case where the substitutive sheet is of the equivalent size to that of the original tab sheet (S304: Yes), or in the steps S308 to S310 in the case where the substitutive sheet is of a larger size than that of the original tab sheet (S304: No).

If the substitutive sheet is of the equivalent size to that of the original tab sheet (S304: Yes), the printing image is created in such a way that the output contents to be printed on the tab according to the aforementioned tab setting information are shifted by a sufficient length for allowing them to fit into the surface of the substitutive sheet determined in S303 (S305). Next, the first auxiliary line that represents the outer edge of the tab sheet (i.e. the edge on the side where the tab is located) is combined into the printing image (S306). At this time, the particular first auxiliary line is located apart from the outer edge of the substitutive sheet at a distance of the same length as the shift length explained in S304. Next, the second auxiliary line that represents the tab shape is further combined into said printing image based on the tab setting information (S307). The particular second auxiliary line is placed in such a way that it properly represents the outer edge of the tab sheet in conjunction with the first auxiliary line.

Also, if the substitutive sheet is of a larger size than the original tab sheet (S304: No), the printing image of the output contents to be printed on the tab is created firstly (S308). In this case, since the contents to be printed on the tab will sufficiently fit into the substitutive sheet, there is no need to shift the tab image like in S305. Next, the first auxiliary line representing the edge of the tab sheet (i.e. the edge on the side where the tab is located) is combined into the printing image (S309), and then the second auxiliary line representing the tab's outer shape is also combined into the printing image based on the tab setting information (S310).

Once the printing image is created with these two kinds of auxiliary lines being combined, the information necessary for specifying the tab sheet to be inserted such as “Output contents”, “Index number”, etc. is further combined into the printing image (S311), and then the sequence is terminated.

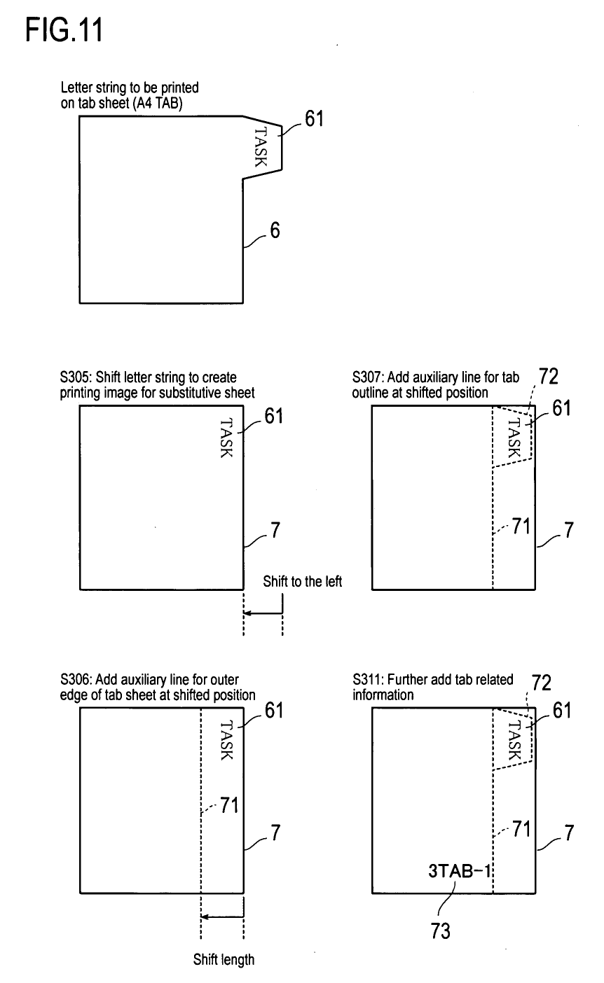

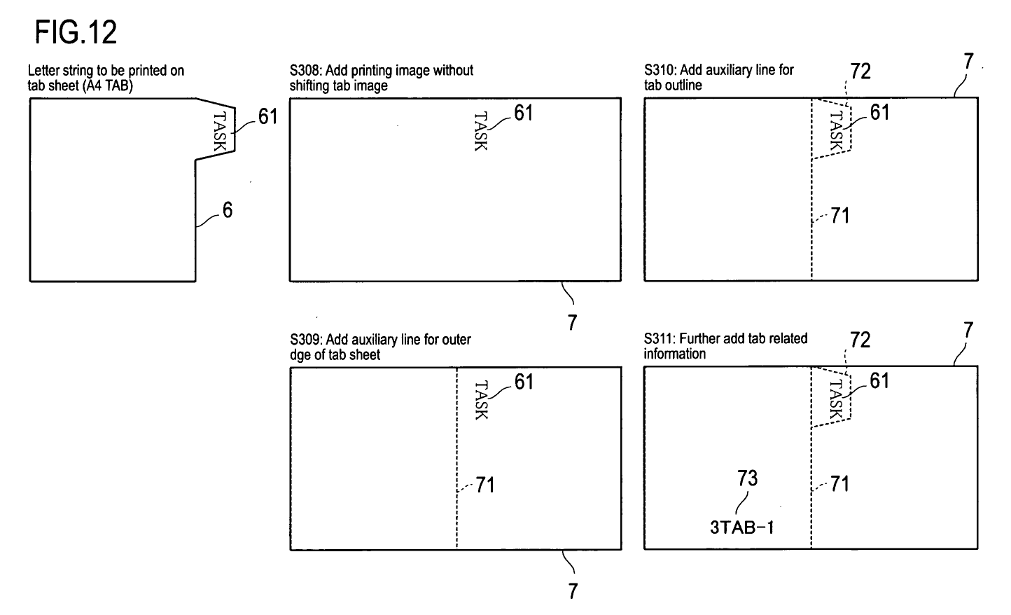

Next, FIG. 11 and FIG. 12 illustrate in detail how the printing image for the substitutive sheet is created. In this relation, an assumption is made that “A4TAB” is assigned as “Paper size”, “3” is assigned as “Number of indexes”, “1” is assigned as “Index number”, and “Task” is assigned as “Output contents”.

FIG. 11 is an illustration showing how the printing image is created in the case when the size of the substitutive sheet 7 specified on the UI screen 5 is equivalent to that of the original tab sheet 6, i.e., the size of the substitutive sheet 7 is A4. Referring to FIG. 11, in accordance with S305, the printing image is created in such a way that the output contents 61 on the tab is shifted horizontally by a sufficient length for allowing the contents on the tab to fit into the surface of the substitutive sheet 7 of the A4 size. That sufficient length should be longer than the tab width contained in the tab setting information, or more preferably be several tens of millimeters to 1 centimeter longer than the tab width, considering the usefulness for the user, so that the output contents 61, the first auxiliary line 71, and the second auxiliary line 72 can all fit within the surface of the substitutive sheet 7. Next, in accordance with S306, the first auxiliary line 71 representing the right edge of the tab sheet 6, is added at a location apart from the right edge of the substitutive sheet 7 by the same length as the shift length mentioned above and, in accordance with S 307, the second auxiliary line 72 representing the outline of the tab of the tab sheet 6 is added at a location corresponding to that of the first auxiliary line 71. The outline of the tab represented by the second auxiliary line 72 is determined by the setup conditions concerning the tab sheet included in the tab setting information. Lastly, in accordance with S311, the letter string “3TAB-1” is added as the tab information 73 based on the tab setting information, and this means that the letter string “Task” shall be printed on the first tab paper out of the three. The tab information 73 can include any information that is useful for identifying the tab sheet to be inserted.

FIG. 12 is an illustration showing how the printing image is created in the case when the size of the substitutive sheet 7 specified on the UI screen 5 is larger than that of the original tab sheet 6, i.e., the size of the substitutive sheet 7 is A3. Referring to FIG. 12, the printing image is created in accordance with S308 without having the printout contents 61 shifted as they can sufficiently fit into the surface of the substitutive sheet 7. Next, in accordance with S309 and S310, the first auxiliary line 71 representing the right edge of the tab sheet 6 and the second auxiliary line 72 representing the outline of the tab are added at the locations corresponding to that of the output contents 61. Furthermore, the information 73 concerning the tab sheet is added in S311. The details in the steps S309 to S311 are omitted as they are the same as explained in FIG. 11.

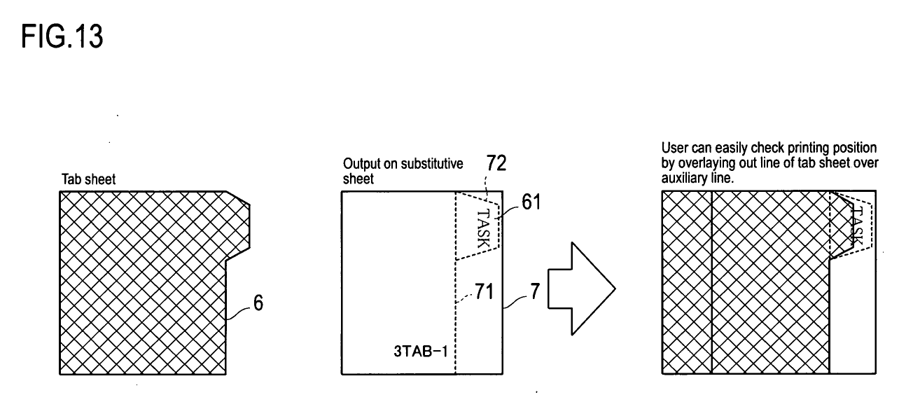

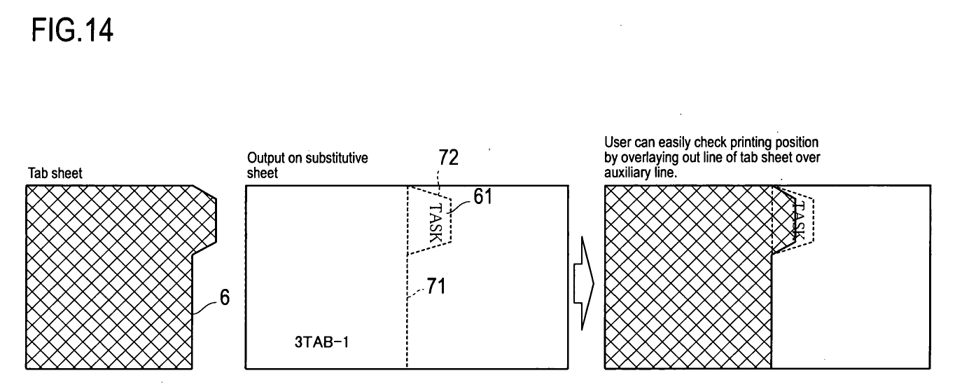

As can be seen from the above, the user executing the proof printing of the document data for the tab printing, can easily check the printing position on the tab, and therefore the chance of wasting expensive tab sheets due to the fact that the output results of the proof printing turn out to be unsatisfactory to the user will be reduced. More specifically, as shown in FIG. 13 and FIG. 14, the user can easily check the position of the output contents 61 to printed on the tab by overlaying the outline of the real tab sheet 6 on the virtual tab outline comprising the first auxiliary line 71 and the second auxiliary line 72 printed on the substitutive sheet 7. The usefulness for the user can be improved by printing on the substitutive sheet the information 73 provided for identifying the tab sheet to be inserted. The usefulness for the user can further be improved by printing the first auxiliary line 71, the second auxiliary line 72 and the information 73 in a color different from that of the output contents 61, or by shifting the entire printing data for all the pages, or the printing data for the pages before and after the page for the tab insertion by the same length as the shift length of the output contents 61, in the case when the output contents 61 are shifted for the proof printing.

The invention is not limited to the embodiment described above, but also can be changed in various ways within the scope of the claims. For example, although the MFP was used to represent the image forming apparatus in the above embodiment, the present invention is not limited to it and the image forming apparatus can be a printer, copying machine, etc. as well. Also, the function of adding the auxiliary lines representing the tab sheet to the printing image, was realized on the MFP side, the present invention is not limited to it and said function can be realized on the PC side as well. In other words, the printer driver can also have the function of adding the auxiliary lines representing the outer edge of the tab sheet.

The means and method of conducting various processes in the printing system according to the present invention can be realized by means of a dedicated hardware circuit, or a programmed computer. The abovementioned program can be provided by a storage medium such as a flexible disk or a CD-ROM. In this case, the program recorded on the computer readable storage medium is normally transferred to and stored in a memory unit such as a hard disk. Said program can also be provided as independent application software or can be built into the software of the image processing device as a part of its function.

What is claimed is:

1. An image forming method for executing proof printing based on a printing job for printing images on recording sheets including a tab sheet, comprising the steps of:
1) selecting an substitutive sheet to be used in place of a tab sheet specified in said printing job; and
2) giving an instruction to print a tab image to be printed on the tab of said tab sheet and an outline image representing at least a portion of the outline of said tab sheet, on said substitutive sheet selected in said step 1).

2. The image forming method as claimed in claim 1, wherein
in said step 2), said tab image and said outline image are shifted by a length that causes said tab image and said profile image to fit into the surface of said substitutive sheet.

3. The image forming method as claimed in claim 1 wherein
in said step 2), an instruction is given to print information that specifies the tab sheet to be used.

4. An image forming system for executing proof printing based on a printing job for forming images on recording sheets including a tab sheet, comprising:
a selection unit for selecting an substitutive sheet to be used in place of said tab sheet specified in said printing job; and
a printing instruction unit for making an instruction to print a tab image to be printed on the tab of said tab sheet and an outline image representing at least a portion of the outline of said tab sheet, on said substitutive sheet selected by said selection unit.

5. The image forming system as claimed in claim 4, wherein
said printing instruction unit further shifts said tab image and said outline image by a length that causes said tab image and said outline image to fit into the surface of said substitutive sheet.

6. The image forming system as claimed in claim 4, wherein
said printing instruction unit further gives an instruction to print information for identifying the tab paper to be used.

7. An image forming apparatus for executing proof printing based on a printing job for forming images on recording sheets including a tab sheet, comprising:
a selection unit for selecting an substitutive sheet to be used in place of said tab sheet specified in said printing job; and
a printing unit for printing a tab image to be printed on the tab of said tab sheet and an outline image representing at least a portion of the outline of said tab sheet, on said substitutive sheet selected by said selection unit.

8. The image forming apparatus as claimed in claim 7 wherein
said printing unit further shifts said tab image and said outline image by an length that causes said tab image and said outline image to fit into the surface of said substitutive sheet.

9. The image forming apparatus as claimed in claim 7 wherein
said printing unit further prints information for identifying the tab paper to be used.

10. A computer readable storage medium stored with an image forming program for executing proof printing based on a printing job for forming images on recording sheets including a tab sheet, said image forming program causing an image forming apparatus to execute the steps of:
1) selecting an substitutive sheet to be used in place of said tab sheet specified in said printing job; and
2) printing a tab image to be printed on the tab of said tab sheet and an outline image representing at least a portion of the outline of said tab sheet, on said substitutive sheet selected in said step 1).

11. The computer readable storage medium as claimed in claim 10, wherein
in said step 2), said tab image and said outline image are shifted by an length that causes said tab image and said outline image to fit into the surface of said substitutive sheet.

12. The computer readable storage medium as claimed in claim 10, wherein
in said step 2), information for identifying the tab paper to be used, is further printed.
